(19) United States
(12) Patent Application Publication
(10) Pub. No.: US 2009/0272326 A1
(43) Pub. Date: Nov. 5, 2009

(54) Apparatus for Feeding, Training, and Amusing Animals

(76) Inventor: Roger Bacon, Los Angeles, CA (US)

Correspondence Address: MARC E. HANKIN, ESQ., 11414 THURSTON CIRCLE, LOS ANGELES, CA, 90049, US

(21) Appl. No.: 12/113,732

(22) Filed: May 1, 2008

(51) Int. Cl. A01K 29/00; A01K 1/00; A01K 15/00

(52) U.S. Cl. 119/57.92; 119/61.55; 119/707; 119/720

(57) ABSTRACT

Various embodiments of this invention are directed towards an apparatus for feeding, amusing, and training animals and pets. Various embodiments of the invention comprise a remote control vehicle that is configured to feature a vessel. The vessel may be loaded with foods or treats in order to reward an animal that successfully completes a chase of the vehicle.

### FIELD OF INVENTION

Various embodiments of this invention relate, generally, to apparatus for feeding, training, and amusing animals; more particularly, to apparatus for training and amusing animals that allow a trainer to interact with an animal through the use of a remote control vehicle.

### BACKGROUND

In the art of animal and pet training, trainers are challenged with amusing animals while feeding and training them. Animal and pet trainers, meanwhile, are challenged to devise devices that amuse animals or pets, allow trainers to interact with the animal or pet, and reward the animals or pets for good behavior.

Examples of such devices are disclosed by U.S. Pat. Nos. 5,524,326, 5,765,508, 5,675,225, 4,391,224, and 6,371,053 and U.S. Patent Application Nos. 2006/0154558, 2006/0112898, 2007/0017454, and 2006/0150918. These various devices and apparatus disclose remote control devices, which allow the trainer to control the movement of an object which the animal or pet chases or plays with. U.S. Pat. No. 5,524,326, for example, discloses a game played with a pet in which a remote controlled animal is chased in and out of an enclosure by a pet, such as a cat.

None of these patent and patent applications, however, disclose a device wherein the pet or animal may interact with a remote control device, which further features a reward system if the animal is able to capture the device. The Inventor speculates (but does not specifically claim) that such a reward is beneficial in the training process because it simulates the satisfaction that an animal receives at the conclusion of a successful chase. Such rewarding behavior is generally classified in the art as “reinforcement” and this device is speculated to improve reinforcement techniques.

Thus, there remains a long felt need in the art for a remote controlled device or apparatus that allows trainers to interact with an animal or pet and rewards the pet at the conclusion of the successful chase.

### SUMMARY OF THE INVENTION

Various embodiments of this invention are directed towards a remote controlled device or apparatus that allows trainers to interact with an animal or pet and rewards the pet or animal at the conclusion of the successful chase.

Various embodiments of the invention comprise a remote controlled vehicle whose body is configured to reward the pet or animal, which chases the remote controlled vehicle at the conclusion of a successful chase. In various embodiments of the invention, the body is configured to comprise a vessel, which may be loaded with pet food or other treats that reward the pet at the conclusion of a successful chase.

In various embodiments of the invention, the vessel further features a lid. The lid, in various embodiments of the invention, is configured in order to allow pets and animal to access the foods and treat within the vessel. Meanwhile, the lid is further configured in order to keep the food and treats within the vessel, while the vehicle is in motion.

Various embodiments of the invention feature variably configured body, in order to present various designs. In various embodiments of the invention, the body may, for example, comprise a rabbit doll, a turtle doll, a doll shaped as another animal, or a body shaped as a pet bowl or other vessel.

### BRIEF DESCRIPTION OF THE DRAWINGS

FIG. 1 is an illustration from a perspective view of various embodiments of the invention with the body in place.

FIG. 2 is an illustration from a bottom view of various embodiments of the invention.

FIG. 3 is an illustration from a top view of various embodiments of the invention with the body removed.

FIG. 4 is an illustration from a side view of various embodiments of the invention with the body removed.

FIG. 5 is an illustration from a side view of various embodiments of the invention with the body in place.

FIG. 6 is an illustration from a side view of various embodiments of the invention with the body in place.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/ or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “remote control vehicle” refers to any of the various two-wheeled, three-wheeled, four-wheeled, or tractor-tread land-going vehicles known in the art; “body” refers to any of the various coverings using to cover a remote control vehicle chassis; and “vessel” refers to any container, cask, bottle, kettle, cup, or bowl for holding foods, drinks, or other treats for animals or pets that capture the vehicle.

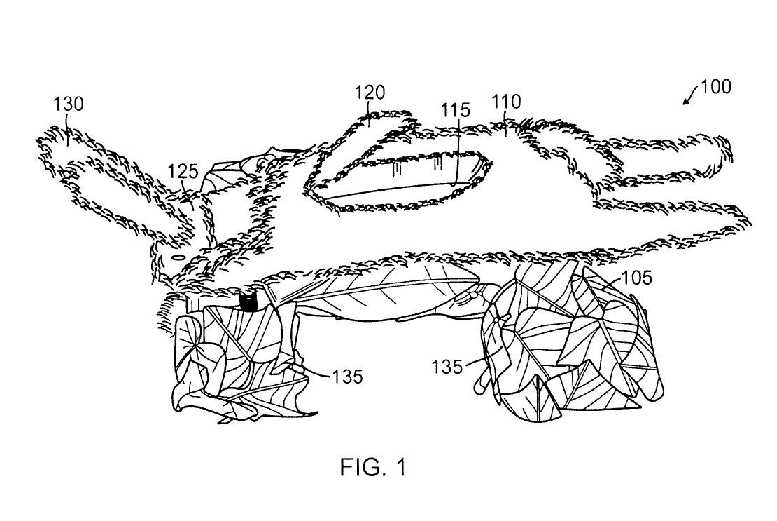

FIG. 1 is an illustration from a perspective view of various embodiments of the invention with the body in place. A remote controlled vehicle 100 is shown along with its various constituent parts, including the chassis 105, the body 110, the vessel 115, and the vessel lid 120. In various embodiments of the invention, the body 110 is configured to resemble a rabbit. In this embodiment, the body 110 features a rabbit head 125 and rabbit ears 130, which may be used to conceal the remote control vehicle 100 antenna. In various embodiments of the invention, faux foliage 135 may be used to conceal portions of the remote control vehicle 100, such as the vehicle's tires.

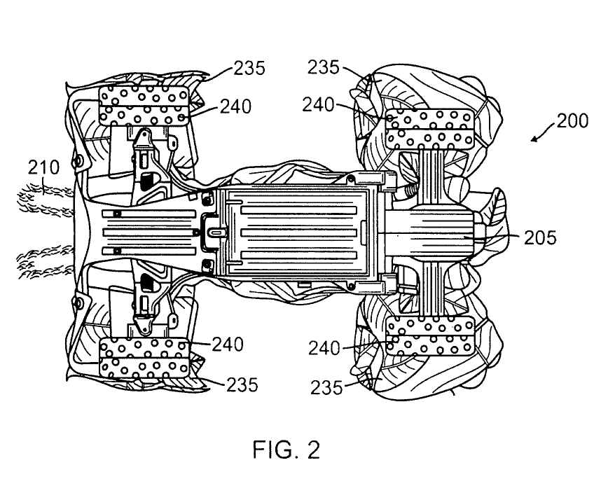

FIG. 2 is an illustration from a bottom view of various embodiments of the invention. A remote controlled vehicle 200 is shown along with its various constituent parts, including the chassis 205, the body 210. The faux foliage 235 is used to conceal the remote control vehicle's 200 tires 240.

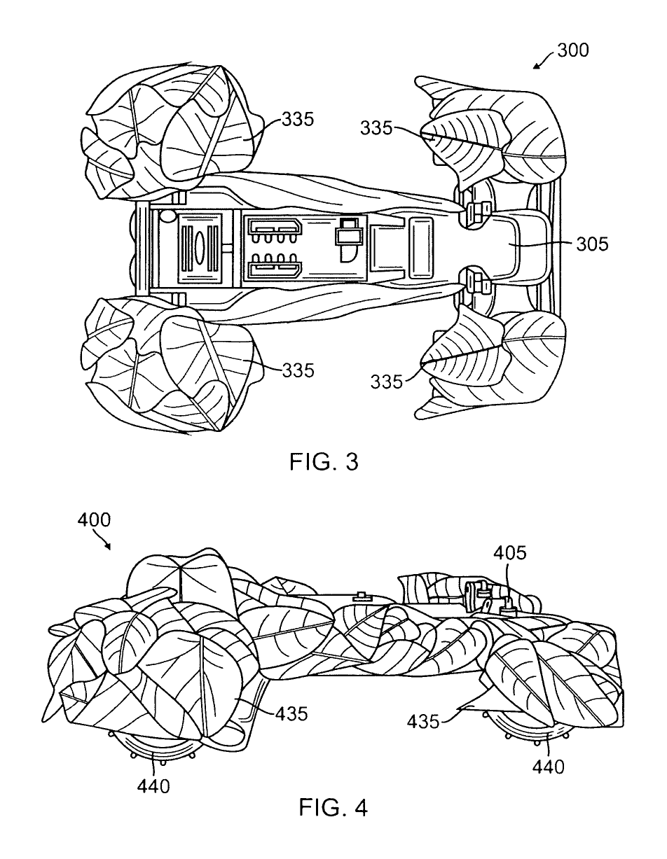

FIG. 3 is an illustration from a top view of various embodiments of the invention with the body removed. A remote controlled vehicle 300 is shown along with its various constituent parts, including the chassis 305 and the faux foliage 335, which is used to conceal the remote control vehicle's 300 tires.

FIG. 4 is an illustration from a side view of various embodiments of the invention with the body removed. A remote controlled vehicle 400 is shown along with its various constituent parts, including the chassis 405 and the faux foliage 435, which is used to conceal the remote control vehicle's 400 tires 440.

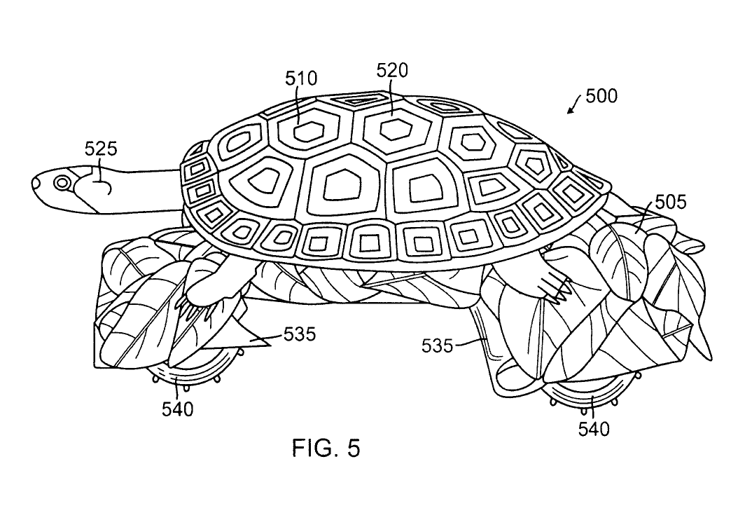

FIG. 5 is an illustration from a side view of various embodiments of the invention with the body in place. A remote controlled vehicle 500 is shown along with its various constituent parts, including the chassis 505, the body 510, and the vessel lid 520. In this illustration, the vessel lid 520 is illustrated while closed. In various embodiments of the invention, the body 510 is configured to resemble a turtle. In this embodiment, the body 510 features a turtle head 625, which may be used to conceal the remote control vehicle 500 antenna. In various embodiments of the invention, faux foliage 535 may be used to conceal portions of the remote control vehicle 500, such as the vehicle's tires 540.

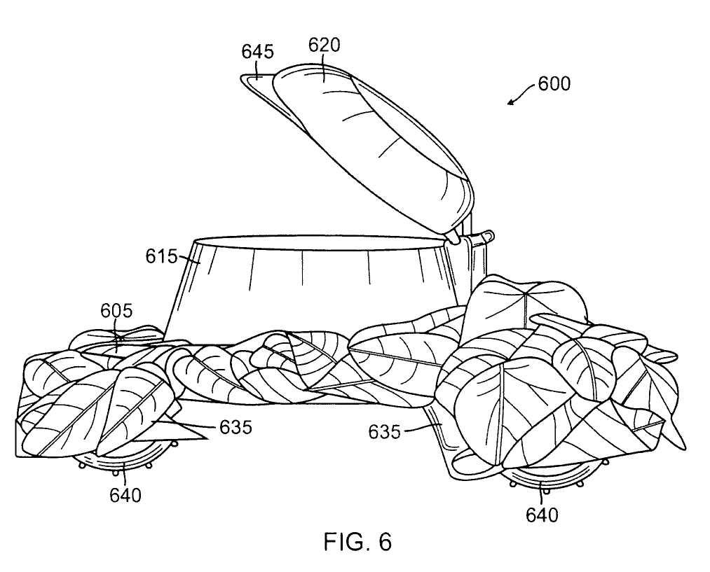

FIG. 6 is an illustration from a side view of various embodiments of the invention with the body in place. A remote controlled vehicle 600 is shown along with its various constituent parts, including the chassis 605, the vessel 615, and the vessel lid 620. In various embodiments of the invention, the vessel 615 is shaped as a pet bowl and features a vessel lid 620 that is spring loaded to automatically close. The lid 620 features a lip 645, which allows the pet or animal to open the vessel 615. In various embodiments of the invention, faux foliage 135 may be used to conceal portions of the remote control vehicle 100, such as the vehicle's tires.

What is claimed is:

1. A device for feeding, amusing, or training animals or pets, comprising:
a remote controlled vehicle, said remote controlled vehicle comprising a wireless receiver configured to wirelessly receive signals from a wireless transmitter operated by a user and said receiver being configured to control the motion of said remote controlled vehicle based on said signals received from said wireless transmitter,
a body, said body being configured to comprise the outside shell of said remote control vehicle, and
a vessel, said vessel being configured to feature an opening which may be filled with pet or animal foods, liquids, or treats.

2. A device for feeding, amusing, or training animals or pets according to claim 1, wherein said vessel further comprises a vessel lid, said vessel lid being configured to feature a closing mechanism.

3. A device for feeding, amusing, or training animals or pets according to claim 1, wherein the opening of said vessel is configured to be on the outside of said body.

4. A device for feeding, amusing, or training animals or pets according to claim 2, wherein said closing mechanism comprises a spring loaded vessel lid.

5. A device for feeding, amusing, or training animals or pets according to claim 2, wherein said closing mechanism comprises hook-and-loop fasteners.

6. A device for feeding, amusing, or training animals or pets according to claim 2, wherein said vessel lid further comprises a lip, said lip being configured to allow animals to open said vessel lid.

7. A device for feeding, amusing, or training animals or pets according to claim 1, wherein the body is configured to resemble the body of an animal, insect, or rodent.

8. A device for feeding, amusing, or training animals or pets according to claim 1, wherein the body is configured to resemble a pet bowl.

9. A device for feeding, amusing, or training animals or pets according to claim 1, wherein the body is configured to resemble the body of a rabbit, turtle, hare, lemur, gerbil, cat, mouse, elephant, mole, anteater, hedgehog, pig, camel, or aardvark.

10. A device for feeding, amusing, or training animals or pets according to claim 7, wherein the head of said animal, insect, or rodent is used to conceal an antenna.

11. A device for feeding, amusing, or training animals or pets according to claim 1, wherein the body further comprises faux foliage, said faux foliage being configured to cover one or more portions of said remote control vehicle.

12. A device for feeding, amusing, or training animals or pets according to claim 11, wherein said faux foliage is configured cover the wheels and tires of said remote control vehicle.

13. A device for feeding, amusing, or training animals or pets according to claim 1, wherein the remote controlled vehicle comprises a four-wheeled vehicle.

14. A device for feeding, amusing, or training animals or pets according to claim 1, wherein the remote controlled vehicle comprises a three-wheeled vehicle.

15. A device for feeding, amusing, or training animals or pets according to claim 1, wherein the remote controlled vehicle comprises a tractor-tread vehicle.
